(19) United States
(12) Patent Application Publication
(10) Pub. No.: US 2012/0146446 A1
(43) Pub. Date: Jun. 14, 2012

(54) SINE-WAVE CURRENT LINE-START THREE-PHASE RARE-EARTH PERMANENT MAGNET SYNCHRONOUS MOTOR

(75) Inventors: Qi Lin, Wuhan (CN); Xuan Mi, Wuhan (CN)

(73) Assignee: HUBEI SEEPOMOTOR SCIENCE AND TECHNOLOGY CO., LTD., Wuhan, Hubei (CN)

(21) Appl. No.: 13/391,362

(22) PCT Filed: Aug. 2, 2010
(86) PCT No.: PCT/CN2010/075629

§ 371 Date: Feb. 20, 2012

(30) Foreign Application Priority Data
Sep. 4, 2009 (CN) 200910063832.7

(51) Int. Cl. H02K 19/02

(52) U.S. Cl. 310/162

(57) ABSTRACT

A sine-wave current line-start three-phase rare-earth permanent magnet synchronous motor includes a motor shaft, a rotor and a stator. The rotor is disposed inside the stator and rotates around the motor shaft. The rotor includes P pairs of poles. Each pole includes a polar arched surface. A planar surface is formed between adjacent polar arched surfaces. Thus, a non-uniform air gap is formed between the pole face of the rotor and the inner circumferential surface of the stator. By the use of a salient-pole structure with the non-uniform air gap, the asymmetry of the magnetic circuit caused by permanent magnets can be offset, thereby making the manufacturing process of the rotor simplified, the negative sequence components of the rotor current during the line starting process reduced significantly, the starting performance improved, the sine-wave current provided during the operating process, the harmonic loss reduced, and the motor efficiency enhanced.

### FIELD OF THE INVENTION

The present invention generally relates to a permanent magnet motor, and more particularly, to a self-starting three-phase rare-earth permanent magnet synchronous motor having a sinusoidal current.

### BACKGROUND OF THE INVENTION

Currently, in China, the power consumption of all kinds of motors is about 70% of the domestic total power generation capacity. Most of the motors are three-phase asynchronous motors that are directly operated in the grids, but the practical operational efficiency is generally very low and the electric energy is severely wasted. Therefore, as long as the power saving of the motor is achieved, the overall power saving is solved.

A stator of a self-starting three-phase rare-earth permanent magnet synchronous motor has the same structure as that of a common three-phase asynchronous motor. A starting winding and a high-performance rare-earth permanent magnet are set on a rotor. In a start process, the starting winding generates a torque to drag the motor to start rotation. When a synchronous rotation speed is approached, the motor operates in a normal operating state as the permanent magnet functions to pull the motor to the synchronous rotation speed. As no copper consumption of the rotor occurs during operation of a self-starting three-phase rare-earth permanent magnet synchronous motor, and meanwhile, as an excitation field of the motor is provided by the permanent magnet, a relatively high power factor may occur in the entire load range, and the copper consumption of the stator is clearly reduced. Compared a common asynchronous motor, a self-starting three-phase rare-earth permanent magnet synchronous motor has properties of strong start and overload capabilities, good operational stability, a same rotational speed, a smaller volume, a light weight, low noise, and high efficiency, which can save the energy by 10% to 40%. In use, the self-starting three-phase rare-earth permanent magnet synchronous motor requires no other auxiliary apparatuses so that the installation and use are convenient, can directly replace the existing three-phase asynchronous motor, and is applicable to the industries such as oil field, coal, steel rolling, spinning, chemical engineering, automobiles, and ships.

Since the 90s of the last century, the research and development of the rare-earth permanent magnet motor have already entered a new stage domestically and internationally. However, the self-starting three-phase rare-earth permanent magnet synchronous motor because of its complexity has failed to achieve desirable advances. The major cause is that there are a large amount of harmonics in the current resulted from conventional designs of the magnetic path of a motor, which affects the starting performance of the motor on one hand and greatly increases the loss during the operation of the motor on the other hand, whereby that the efficiency of the motor is decreased and the power saving potential of the motor is not fully exerted. Furthermore, the large amount of harmonics in the current may also severely pollute to the grids.

At present, although people have already done a lot of work on enhancing and improving the structural performance of a self-starting three-phase rare-earth permanent magnet synchronous motor, a good sinusoidal current waveform is still unable to be obtained and the harmonic problem is still not completely solved. For example, in the Chinese patent No. 200710158557.8, entitled “SELF-STARTING HIGHLY-EFFECTIVE PERMANENT MAGNET SYNCHRONOUS MOTOR” and the Chinese patent No ZL200520100814.9, entitled “NEW-TYPE SELF-STARTING PERMANENT MAGNET SYNCHRONOUS MOTOR”, the structural performance of the self-starting synchronous motor is enhanced and improved to a certain degree, but a good sinusoidal current is not ensured and the harmonic problem still exists.

Furthermore, in the Chinese patent No. ZL00252876.2, entitled “SINUSOIDAL PERMANENT MAGNET MAGNETIC FLUX DENSITY WAVEFORM PERMANENT MAGNET SYNCHRONOUS MOTOR”, an uneven air gap is realized through eccentricity between an inner circle of the stator and an external circle of the rotor of the motor, so as to improve a magnetic flux density waveform, but still cannot effectively improve the symmetry of a magnetic path and obtain a good sinusoidal current.

Therefore, a heretofore unaddressed need exists in the art to address the aforementioned deficiencies and inadequacies.

### SUMMARY OF THE INVENTION

In one aspect, the present relates to a sinusoidal (or sine-wave) current line-start (or self-starting) three-phase rare-earth permanent magnet synchronous motor that solves the forgoing mentioned technical problems. The line-start three-phase rare-earth permanent magnet synchronous motor can achieve an excellent sinusoidal current during the operation, so that the harmonic loss can be reduced and the efficiency of the motor can be enhanced significantly.

In one embodiment, the sinusoidal current line-start three-phase rare-earth permanent magnet synchronous motor includes a motor shaft, a rotor, and a stator. The rotor is arranged inside the stator. In operation, the rotor rotates around the motor shaft. A pole face of the rotor includes P pairs of poles. Each pole includes one polar arced surface. A plane exists between adjacent polar arced surfaces. In one embodiment, P is a natural number greater than or equal to 2.

In the sinusoidal current line-start three-phase rare-earth permanent magnet synchronous motor, an angle ratio of β and a of each pole is between 1.5 and 10.0, where β is an angle defined between a first ray and a second ray; α=(360°/4P)−β. In one embodiment, the first ray is a radial line from an axis of the motor shaft (1) through a vertex of a projection of the polar arced surface (302) on an axial projection of the motor. The second ray is a radial line from the axis of the motor shaft (1) through an intersecting point of the projection of the polar arced surface (302) and a projection of the plane (301) on the axial projection of the motor.

Further, in the sinusoidal current line-start three-phase rare-earth permanent magnet synchronous motor, for each pole of the rotor pole face, a ratio among a minimal air gap, a medium air gap, and a maximal air gap is about 1:(1.2 to 3):(2.5 to 10.0).

In one embodiment, the minimal air gap is a distance from an intersecting point between the first ray and the projection of the polar arced surface (302) to an intersecting point between the first ray and a projection of an inner circular surface of the stator on the axial projection of the motor. The medium air gap is a distance from an intersecting point between the projection of the polar arced surface (302) and the projection of the plane (301) to an intersecting point between the second ray and the projection of the inner circular surface of the stator on the axial projection of the motor. The maximal air gap is a distance from a midpoint of a line segment of the projection of the plane (301) at one side of the polar arced surface to an intersecting point between a radial line from the axis of the motor shaft (1) and through the midpoint and the projection of the inner circular surface of the stator on the axial projection of the motor.

Additionally, in the sinusoidal current line-start three-phase rare-earth permanent magnet synchronous motor, on the axial projection of the motor, the projection of the polar arced surface (302) is an arc having its circular center located on the first ray and distanced from the axis of the motor shaft (1).

Compared with the prior art, the sinusoidal current line-start three-phase rare-earth permanent magnet synchronous motor according to the present invention has at least the followings advantages.

1. The pole face of the rotor of the present invention includes P pairs of poles (2P poles), each pole includes one polar arced surface, and a plane exists between adjacent polar arced surfaces, so that an uneven air gap is formed between the pole face of the rotor and the inner circular surface of the stator. According to the present invention, the characteristic of the salient pole structure of the uneven air gap is utilized to counteract the asymmetry of the magnetic paths caused by the permanent magnet, so that the asymmetry of the magnetic paths is improved, which makes the fabrication process of the rotor structure simple. Further, negative sequence components of the rotor current in the self-starting process of the motor can greatly be reduced, thereby enhancing the start performance of the motor, and meanwhile achieving an excellent sinusoidal current during the operation of the motor. Accordingly, the harmonic loss is reduced and the efficiency of the motor is enhanced.

2. By adjusting the ratio of the arced surface portion and the plane portion of the rotor pole face and the size of the air gap, an excellent sinusoidal magnetic flux density can be obtained, so as to further reduce the negative sequence components of the rotor current in the self-starting process of the motor and improve a start performance of the motor, and meanwhile to achieve an excellent sinusoidal current during the operation of the motor, so that the harmonic loss is further reduced and the efficiency of the motor is further enhanced.

These and other aspects of the present invention will become apparent from the following description of the preferred embodiments, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention only. The shapes, positions, quantities, and movements of parts in the drawings are to illustrate the execution of functions and processing steps and they are by no means represent all the possible alternative implementations covered by this invention.

FIG. 1 is a partial schematic sectional structural diagram according to embodiment 1 (a four-pole motor) of the present invention.

FIG. 2 is a partial schematic sectional structural diagram according to embodiment 2 (a six-pole motor) of the present invention.

FIG. 3 is a partial schematic sectional structural diagram according to embodiment 3 (an eight-pole motor) of the present invention.

FIG. 4 is a partial schematic sectional structural diagram according to embodiment 4 (a ten-pole motor) of the present invention.

FIG. 5 is a partial schematic sectional structural diagram according to embodiment 5 (a twelve-pole motor) of the present invention.

FIG. 6 is a diagram of a measured current waveform during load operation according to embodiment 1 of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. In accordance with the purposes of this invention, as embodied and broadly described herein, this invention, in one aspect, relates to a sinusoidal (or sine-wave) current line-start (or self-starting) three-phase rare-earth permanent magnet synchronous motor.

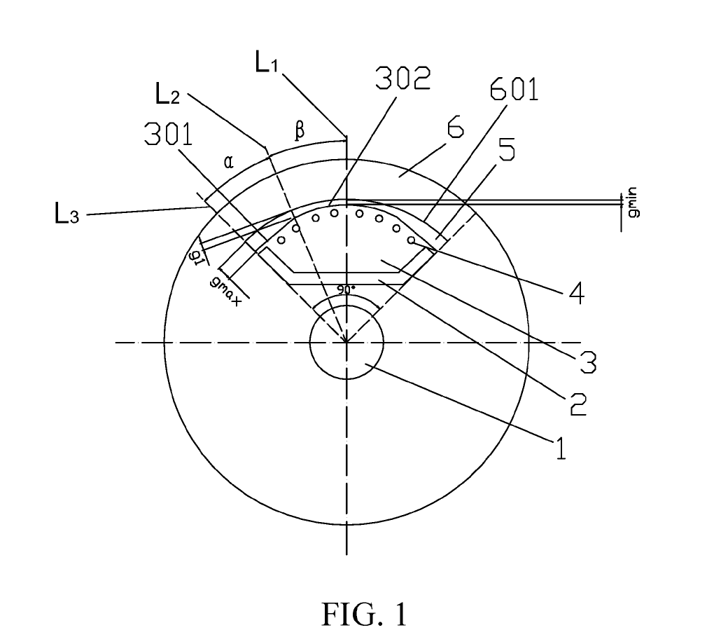

Referring to FIG. 1, a sinusoidal current line-start three-phase rare-earth permanent magnet synchronous motor is schematically shown according to one embodiment of the present invention. In the embodiment, the sinusoidal current line-start three-phase rare-earth permanent magnet synchronous motor includes a motor shaft 1, a rare-earth permanent magnet 2, a rotor (a rotor iron core) 3, rotor starting windings 4, an uneven air gap 5, and a stator (a stator iron core) 6. The rotor 3 is arranged inside the stator 6. In operation, the rotor 3 rotates around the motor shaft 1. The rotor 3 includes P pairs of poles. Each pole includes one polar arced surface 302. A plane 301 exists between adjacent polar arced surfaces. A pole face of the rotor 3 and an inner circular 601 of the stator 6 form the uneven air gap 5.

Generally, P is a natural number greater than or equal to 2.

In Embodiment 1 of the present invention as shown in FIG. 1, a four-pole 7.5-KW sinusoidal current line-start three-phase rare-earth permanent magnet synchronous motor is disclosed. The rotor 3 includes 2 (P=2) pairs of poles. Each pole includes one polar arced surface 302. Further, each pole may also include two plane faces 301 on two sides of the polar arced surface 302, such that, as assembled, a plane 301 exists between adjacent polar arced surfaces. That is, the rotor 3 includes 4 poles and a pole face of the rotor 3 is formed of 4 polar arced surfaces 302 and 4 planes 301.

In the sinusoidal current line-start three-phase rare-earth permanent magnet synchronous motor, an angle ratio of β and α is between 1.5 and 10.0, where β is an angle defined between a first ray L₁ and a second ray L₂; and α=(360°/4P)−β=45°−35°. In this embodiment as shown in FIG. 1, for each pole of the motor, α=10° and β=35°.

The first ray L₁ is a radial line from an axis of the motor shaft 1 through a vertex of a projection of the polar arced surface 302 on an axial projection of the motor.

The second ray L₂ is a radial line from the axis of the motor shaft 1 through an intersecting point of the projection of the polar arced surface 302 and a projection of the plane 301 on the axial projection of the motor.

In one embodiment, each pole of the pole face of the rotor 3 and the inner circular surface 601 of the stator 6 define an uneven air gap 5 having a minimal air gap, gmin, a medium air gap, g1, and a maximal air gap, gmax. The minimal air gap gmin is a distance from an intersecting point between the first ray L₁ and the projection of the polar arced surface 302 to an intersecting point between the first ray L₁ and a projection of an inner circular surface 601 of the stator 6 on the axial projection of the motor. The medium air gap g1 is a distance from an intersecting point between the projection of the polar arced surface 302 and the projection of the plane 301 to an intersecting point between the second ray L₂ and the projection of the inner circular surface 601 of the stator 6 on the axial projection of the motor. The maximal air gap gmax is a distance from a midpoint of a line segment of the projection of the plane 301 at one side of the polar arced surface to an intersecting point between a radial line L₃ from the axis of the motor shaft 1 and through the midpoint and the projection of the inner circular surface 601 of the stator 6 on the axial projection of the motor.

In one embodiment, the ratio among the minimal air gap gmin, the medium air gap g1, and the maximal air gap gmax is about 1:(1.2 to 3):(2.5 to 10.0). In the embodiment of FIG. 1, the minimal air gap gmin is about 0.8 mm, the medium air gap g1 is about 1.5 mm, and the maximal air gap gmax is about 2.5 mm.

In one embodiment, on the axial projection of the motor, the projection of the polar arced surface 302 is an arc having its circular center located on the first ray L₁ and offset from the axis of the motor shaft 1.

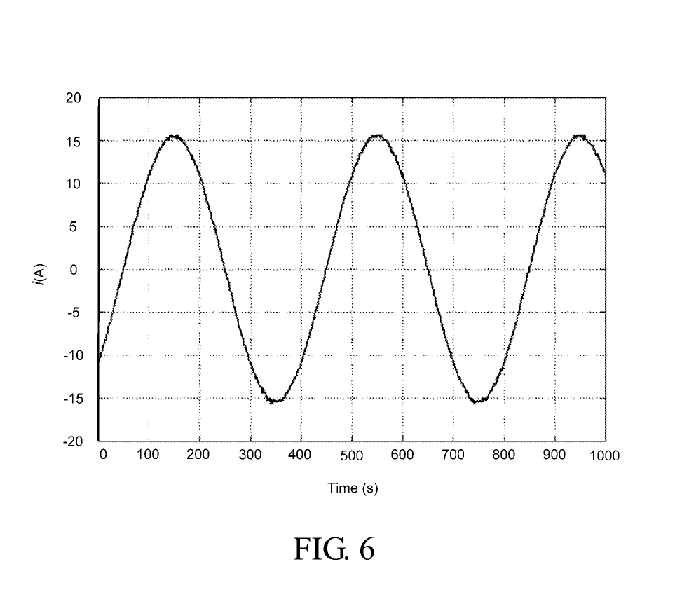

A number of the motors according to embodiment 1 (as shown in FIG. 1) of the present invention were tested for a quite long time, which indicated that the operation is stable, and the power saving effect is significant. The measured current waveform during the load operation of the motor is shown in FIG. 6. Maintaining the sinusoidal feature of the current waveform during the load operation is crucial for enhancement of the efficiency of the motor.

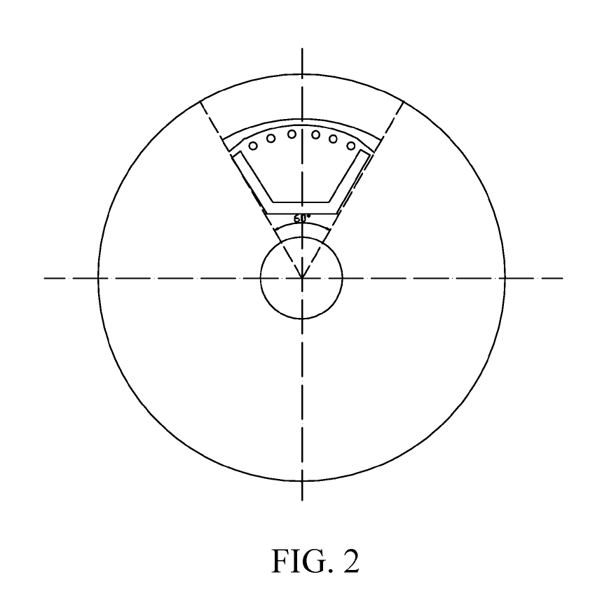

FIG. 2 shows schematically a sinusoidal current self-starting three-phase rare-earth permanent magnet synchronous six-pole motor according to embodiment 2 of the present invention. The structure of the motor is basically the same as that in Embodiment 1. Except that the pole face of the rotor 3 includes 3 (P=3) pairs of poles. Accordingly, α=(360°/4*3)−β=30°−β. The angle ratio of β and α of each pole of the motor is also between 1.5 and 10.0. In the uneven air gap 5, a ratio among a minimal air gap gmin, a medium air gap g1, a maximal air gap gmax is also about 1:(1.2 to 3):(2.5 to 10.0).

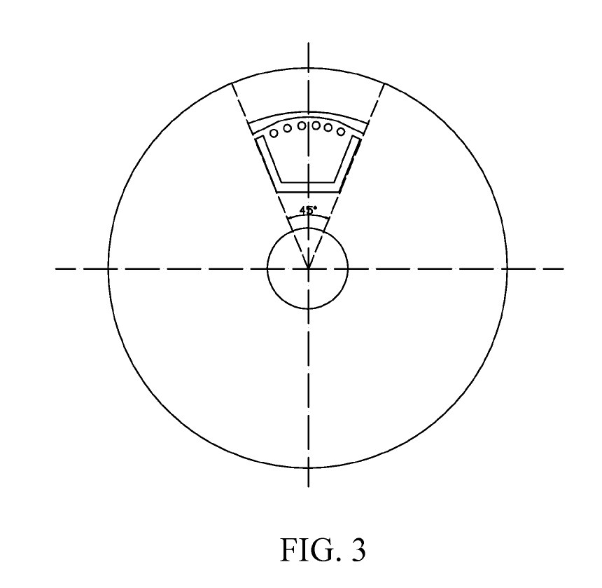

FIG. 3 shows schematically a sinusoidal current self-starting three-phase rare-earth permanent magnet synchronous eight-pole motor according to embodiment 3 of the present invention, which is basically the same as that in Embodiment 2. Except that the pole face of the rotor 3 includes 4 (P=4) pairs of poles, where α=(360°/4*4)−β=22.5°−β.

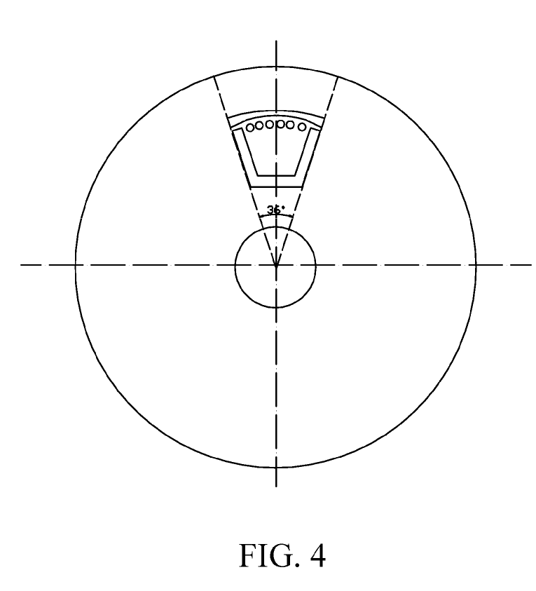

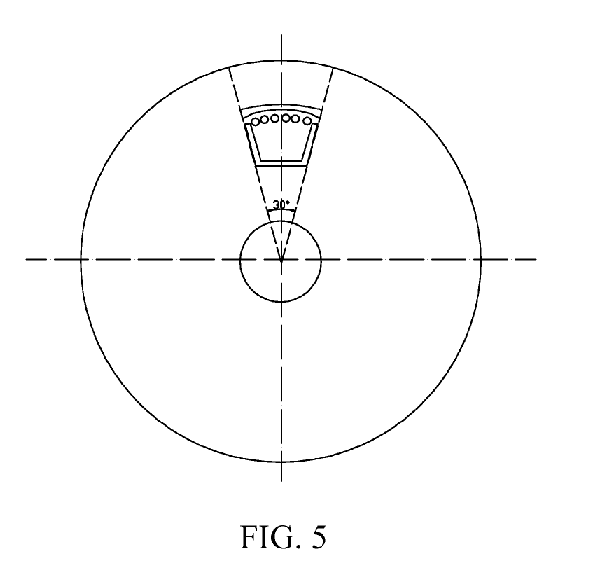

Similarly, embodiments 4 and 5 of the present invention shown in FIG. 4 and FIG. 5 are corresponding to a ten-pole motor and a twelve-pole motor, respectively.

Compared with the existing motors, the motor according to the embodiments of the present invention has at least the following advantages.

1. High Reliability: Usually, in a start process of the motor, the permanent magnet is subject to the influences of a very high alternating magnetomotive impact. At the same time, the temperature of the rotor rises, so the permanent magnet is easily demagnetized. However, the magnetic path structure according to the present invention can not only effectively mitigate the impact influences of the alternating magnetomotive on the permanent magnet, but also further greatly reduce the negative sequence components of the rotor current in a start process, so that the temperature rise of the rotor is reduced. Also, in combination with effective process protection means, it is ensured that the demagnetization phenomenon does not occur on the permanent magnet in any circumstances.

2. Superior Start Performance: The magnetic path structure of the motor according to the present invention can basically eliminate the negative sequence components in the current of the rotor and a unidirectional torque caused thereby, so that the motor can have a suitable start torque in a start process, a relatively small start current and a sufficient capability of pulling into synchronism. Additionally, a pulsating torque in a start process can also effectively be reduced, so as to ensure a superior start performance of the motor.

3. High Efficiency and Power Saving: According to the present invention, in the operation of the motor, no harmonic component exists in the rotor current, so that the loss of the motor is reduced. Further, a reasonable parameter design ensures that the power factor of the motor is near 1 in the entire load range, minimizes the copper consumption in the condition that the motors use the same material, and optimizes the power saving effect of the motor.

4. Low Vibration Noise: According to the present invention, the loss of the more is small and the required cooling air volume is also small, and the cooling fan of a special design also greatly reduces the ventilation noise of the motor. Further, the motor has a large air gap and an excellent current waveform, which apparently reduces pulsating torque and electromagnetic noise. Compared the invented motor with an asynchronous motor with the same specification, the noise of the motor can be reduced by 10 dB to 30 dB.

While there has been shown several and alternate embodiments of the present invention, it is to be understood that certain changes can be made as would be known to one skilled in the art without departing from the underlying scope of the present invention as is discussed and set forth above and below including claims. Furthermore, the embodiments described above and claims set forth below are only intended to illustrate the principles of the present invention and are not intended to limit the scope of the present invention to the disclosed elements.

1. A sinusoidal current line-start three-phase rare-earth permanent magnet synchronous motor, comprising a motor shaft, a rotor, and a stator, wherein the rotor is arranged inside the stator and is rotatable around the motor shaft, and wherein the rotor comprises P pairs of poles, each pole comprises a polar arced surface such that a plane exists between adjacent polar arced surfaces, and P is a natural number greater than or equal to 2.

2. The sinusoidal current line-start three-phase rare-earth permanent magnet synchronous motor according to claim 1, characterized in that an angle ratio of β and α of each pole is between 1.5 and 10.0;
wherein β is an angle defined between a first ray and a second ray, and α=(360°/4P)−β;
wherein the first ray is a radial line from an axis of the motor shaft through a vertex of a projection of the polar arced surface on an axial projection of the motor; and
wherein the second ray is a radial line from the axis of the motor shaft through an intersecting point of the projection of the polar arced surface and a projection of the plane on the axial projection of the motor.

3. The sinusoidal current line-start three-phase rare-earth permanent magnet synchronous motor according to claim 2, characterized in that, for each pole of the rotor, a ratio among a minimal air gap, a medium air gap, and a maximal air gap is about 1:(1.2 to 3):(2.5 to 10.0);
wherein the minimal air gap is a distance from an intersecting point between the first ray and the projection of the polar arced surface to an intersecting point between the first ray and a projection of an inner circular surface of the stator on the axial projection of the motor;
wherein the medium air gap is a distance from an intersecting point between the projection of the polar arced surface and the projection of the plane to an intersecting point between the second ray and the projection of the inner circular surface of the stator on the axial projection of the motor; and
wherein the maximal air gap is a distance from a midpoint of a line segment of the projection of the plane at one side of the polar arced surface to an intersecting point between a radial line from the axis of the motor shaft and through the midpoint and the projection of the inner circular surface of the stator on the axial projection of the motor.

4. The sinusoidal current line-start three-phase rare-earth permanent magnet synchronous motor according to claim 1, characterized in that, on the axial projection of the motor, the projection of the polar arced surface is an arc having its circular center located on the first ray and distanced from the axis of the motor shaft.

5. The sinusoidal current line-start three-phase rare-earth permanent magnet synchronous motor according to claim 2, characterized in that, on the axial projection of the motor, the projection of the polar arced surface is an arc having its circular center located on the first ray and distanced from the axis of the motor shaft.

6. The sinusoidal current line-start three-phase rare-earth permanent magnet synchronous motor according to claim 1, characterized in that an pole face of each pole and an inner circular surface of the stator define an uneven air gap.

7. The sinusoidal current line-start three-phase rare-earth permanent magnet synchronous motor according to claim 6, wherein the uneven air gap has a minimal air gap, a medium air gap, and a maximal air gap, and wherein a ratio among the minimal air gap, the medium air gap, and the maximal air gap is about 1:(1.2 to 3):(2.5 to 10.0).
